(19) United States
(12) Patent Application Publication
(10) Pub. No.: US 2004/0183760 A1
(43) Pub. Date: Sep. 23, 2004

(54) Image data transmission method and device

(76) Inventor: Kuei-Hsiung Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/390,001

(22) Filed: Mar. 18, 2003

(51) Int. Cl. G09G 3/36

(52) U.S. Cl. 345/87

(57) ABSTRACT

The present invention is related to an image data transmission method and device that basically accomplishes image data transmission through the disposal of connecting an image processor directly with a display device. Instead of temporarily storing image data in a central processor and transmitting image data from the central processor to the display device, the present invention enables the central processor to give instructions for the image processor to directly transmit image data to the display device. Insofar as such arrangement is adopted, the image data of the image processor can be directly transmitted to the display device without the intervention of the central processor, and the resource of the central processor will not be occupied. In this manner, the overall performance will be improved, and the memory utilization and power consumption can be reduced significantly.

### FIELD OF THE INVENTION

The present invention is related to an image data transmission method and device, and in particular to an image data transmission method and device that can directly transmit image data to a display device without the intervention of a central processor.

### BACKGROUND OF THE INVENTION

In recent years, the development of 3G mobile phone is flourishing in wireless communication industry, and the competitions arising in wireless communication marketplace are becoming more and more intense. The research and design orientation for mobile phone is trending toward image capturing capability enhancement latterly. In spite of the efforts contributed to such burgeoning high-tech product, some existing drawbacks taken place in an image data display, such as data transmission delay or interruption, have not been conquered yet. In general, when it is desired to transmit image data to a display device, the image data is necessary to be read out by a central processor beforehand, and then transmitted to a display device. Please refer to FIG. 1 which shows a schematic block diagram of a prior art image data transmission device for use in a wireless communication apparatus. As shown in FIG. 1, the prior art image data transmission device includes a display device 10′, a central processor 20′, a memory device 30′, an image processor 40′, and an image sensor 50′. When the central processor 20′ reads image data from the image processor 40′, the received image data is temporarily stored in the memory device 30′. Further, taking a contemporary wireless communication apparatus as an example, the processing sequence of the central processor 20′ will be prioritized with wireless signal reception. If the central processor 20′ is necessary to transmit image data in the middle of wireless signal reception, it will slacken the image data transmission speed or break off image data transmission operation. If so, image data transmission operation will be delayed or interrupted, which results in a serious degeneration of the image data display quality.

Moreover, please refer to FIG. 2 which shows another possible configuration of a prior art image data transmission device for use in a wireless communication apparatus. It is clearly foreseeable from FIG. 2 that the prior art image data transmission device of FIG. 2 adds an auxiliary processor 60′ to partake the loading of the central processor 20′, and therefore the performance of the central processor 20′ is reinforced. However, the circuit design suggested in FIG. 2 is disadvantageous in terms of the additional design cost imposed by the auxiliary processor 60′. Although the overall performance of the image data transmission device is upgraded, it will bring detrimental factors to the promotion of wireless communication product.

There is a continuing demand for proposing a novel image data transmission method and device that can not only overcome the deficiencies of unstable image data transmission speed and poor image data display quality, but reduce design cost. The present invention is addressed in order to cater this demand.

### SUMMARY OF THE INVENTION

A first object of the present invention is to provide an image data transmission device, in which an image processor is connected with a display device so that the image data is directly transmitted from the image processor to the display device with less utilization of the resource of a central processor, and thereby advance the overall system performance and save power consumption.

A second object of the present invention is to provide an image data transmission method which can accelerate the image data transmission speed and improve image data display quality.

A third object of the present invention is to provide an image data transmission method and device with a peculiarity that the image data of an image processor is directly transmitted to a display device without requiring the temporal storage of the image data by a central processor, so that the utilization of memory can be lowered and the whole design cost can be reduced due to little necessity of expansion memory.

A profound object of the present invention is to provide an image data transmission method and device with a peculiarity that the image data of an image processor is directly transmitted to a display device without the intervention of a central processor, so as to remove the auxiliary processor and enhance the competitiveness of wireless communication product.

The present invention is interrelated to an image data transmission method and device in which an image processor is connected to a display device and directly transmits image data to the display device without the requirement of the steps of temporarily storing image data by a central processor and transmitting the image data from the central processor to the display device. The image data transmission method according to the present invention is made by enabling the central processor to give an instruction for the image processor to directly transmit image data to the display device, and give another instruction to floatingly connect the control bus wiring and data bus wiring between the central processor and the display device. In this way, image data can be directly transmitted to the display device without the intermediate of the central processor, so that the resource of the central processor will not be occupied during image data transmission process. The overall performance will be promoted, and the memory utilization and power consumption can be lowered.

The features and advantages of the present invention will become more apparent through the following descriptions with reference to the accompanying drawings, wherein:

### BRIEF DESCRIPTION OF THE DRAWINGS

FIG. 1 is a systematic diagram showing an prior art image data transmission device;

FIG. 2 is a systematic diagram showing another prior art image data transmission device;

FIG. 3 is a control flowchart illustrating the technical procedure for carrying out the image data transmission method according to a preferred embodiment of the present invention;

FIG. 4 is a systematic diagram showing the image data transmission device according to a preferred embodiment of the present invention;

FIG. 5 is a timing diagram illustrating the relationship between signals transmitted over control bus wiring and clock signal lines as well as the image data transmission sequence according to a preferred embodiment of the present invention; and

FIGS. 6, 7 and 8 show several possible interconnections of the clock signals provided in the image data transmission device according to the present invention.

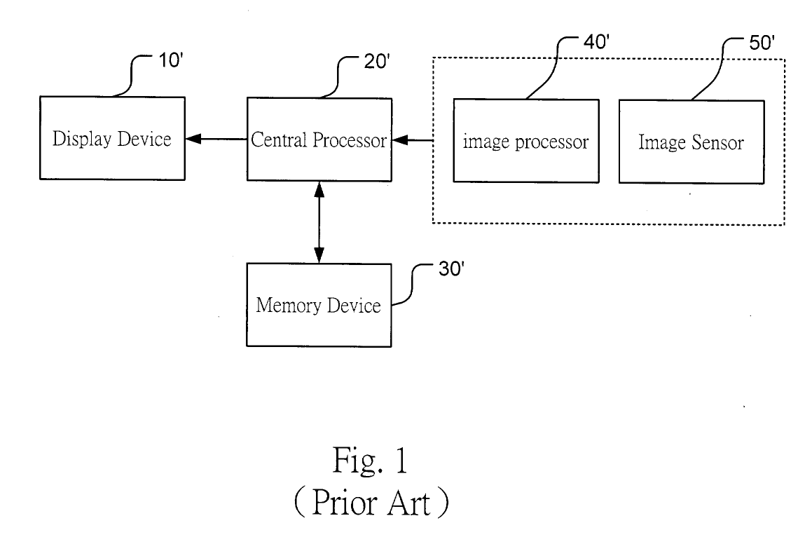

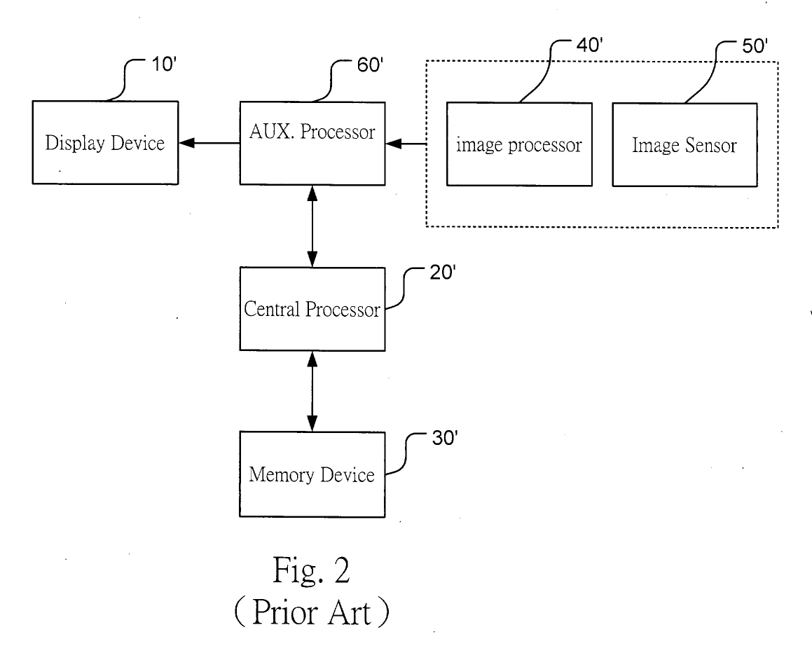

### DETAILED DESCRIPTION OF THE PREFERRED EMBODIMENT

For the purpose of allowing an artisan of ordinary skill in the art to realize the constructional characteristic and achievable efficacy according to the present invention, a preferred embodiment is particularly set forth in the following sections of the specification in reference to the drawings attached therewith. The detailed descriptions of the present invention are specified in the following.

The present invention provides an optimized image data transmission method and device. With the introduction of the present invention, the image data provided by the image sensor can be transmitted and displayed on a display device while eliminating the intervention of the central processor.

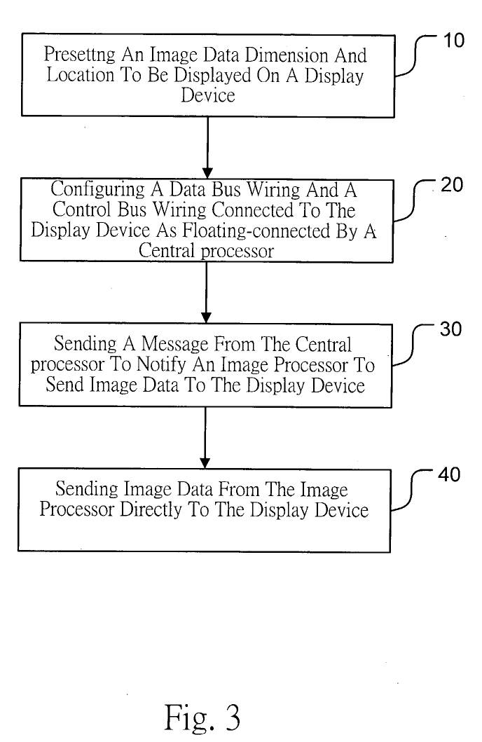

Please refer to FIG. 3 which shows the technical procedure for image data transmission method according to a preferred embodiment of the present invention. As shown, the present invention actually provides a method for image data transmission to a display device without the concernment of the central processor. The major steps of the image data transmission method according to a preferred embodiment of the present invention involves:

Step 10: Preset an image data dimension and location to be displayed on a display device;

Step 20: Configure a data bus wiring and a control bus wiring connected to the display device as floating-connected by a central processor;

Step 30: Send a message from the central processor to notify an image processor to send image data to the display device; and

Step 40: Send image data from the image processor directly to the display device.

At step 10, the image data dimension and location to be display on the display device may be preset by a central processor or an image processor. At step 20, the floating connections of the data bus wiring and the control bus wiring to the display device may be achieved by a software program. At step 30, the message sent out by the central processor may be either a specific signal transmitted over signal lines or a registration information of the software program.

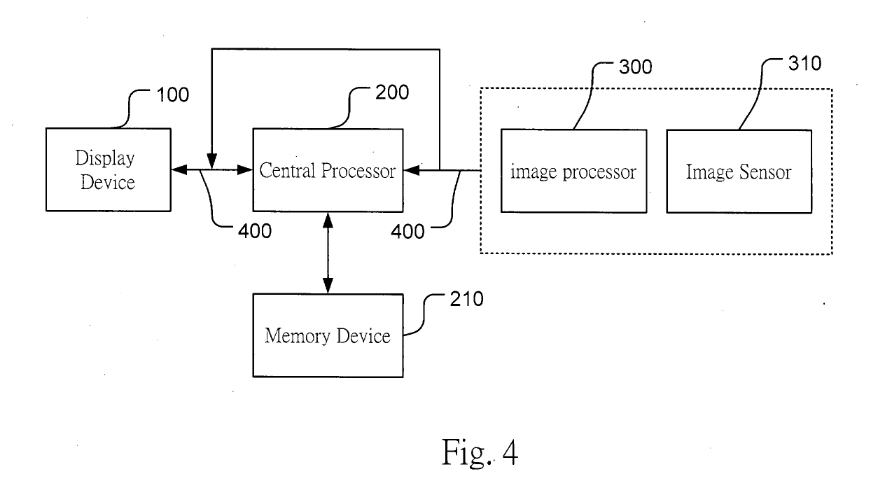

Please refer to FIG. 4 which shows a systematic block diagram of the image data transmission device according to a preferred embodiment of the present invention. As indicated in FIG. 4, the image data transmission device intended to transmit image data according to the present invention at least includes a display device 100 that is used to exhibit image data, a central processor 200 connected with the display device 100, and an image processor 300 interconnected with the display device 100 and the central processor 200.

The display device 100 may be implemented with a TFTLCD (thin-film transistor LCD), a STNLCD (super twisted nematic LCD) or an organic electroluminescent display. A possible arrangement is that the central processor 200 is furnished with a memory device, so that the central processor 200 is implemented with a digital signal processor (DSP). Also, the image processor 300 may be furnished with an image sensor 310 being implemented with a charge-coupled device (CCD) or a CMOS device, wherein the electric wires between the central processor 200 and the display device 100 as well as the image processor 300 are made up of a control bus wiring and a data bus wiring. Besides, the physical connections between the central processor 200 and the display device 100 as well as the image processor 300 can be disposed in a manner that part of the data bus wiring and the control bus wiring are connected with the central processor 200 in parallel. This is because the central processor 200 is a 16-bit integrated circuit that transmit 16 bits in a single transmission clock, while both the image processor 300 and the display device 100 transmits 8 bits in a single transmission clock, wherein only eight signals lines of the central processor 200 are used for parallel connections with part of the data bus wiring and the control bus wiring.

The present invention is primarily based on the intention to lighten the loading of the central processor 20 and promote the image data display quality, such that the data transmission delay or interruption caused the central processor 200 can be obviated. The image data transmission method according to the present invention is also feasible for a conventional image data transmission device with a slight modification made therein. For example, when the central processor 200 instructs the image processor 300 to transmit image data to the display device 100, building an additional instruction in the central processor 200 for notifying the image processor 300 to initiate image data transmission and building another additional instruction in the central processor 200 for causing the control bus wiring and the data bus wiring between the central processor 200 and the display device 100 to be floating-connected, so that the image data transmission method is compatibly applicable to a conventional image data transmission device, and the old-fashioned image data processing procedure of receiving image data by the image processor and transmitted to the display device is usable. The selection of image data transmission depends on the central processor 200.

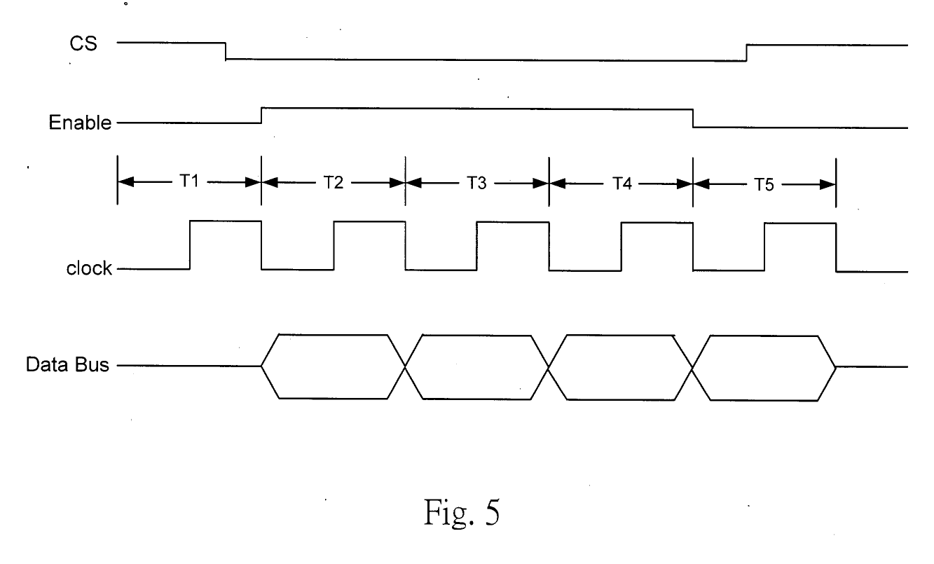

Referring to FIG. 5 which shows a timing diagram according to a preferred embodiment of the present invention. As shown in FIG. 5, CS signal will be active when it stays at a low state, while Enable signal will be inactive when it stays at a low state at time T1. At time T2, CS signal still stays at a low state but the Enable signal stays at a high state, and image data starts to transfer from the image processor to the display device. The operations performed during periods T3 and T4 are identical to the operations performed during T2. During period T5, Enable signal stays at a low state and the image data transmission process is interrupted. It is to be accentuated here that the above-described image data transmission procedure is to be taken as an exemplification for illustrating the image data transmission method of the present invention, and it is not intended to be take as the precise form disclosed.

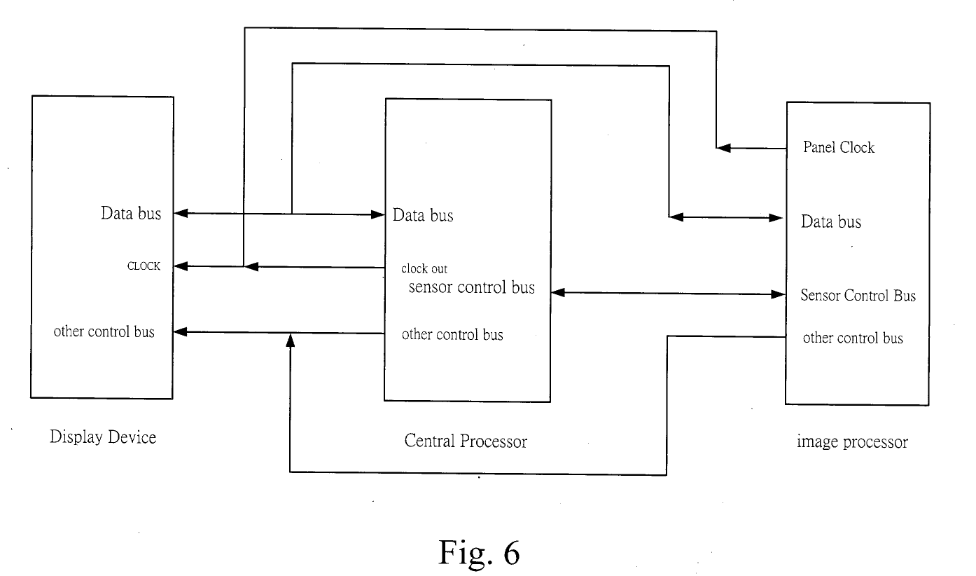

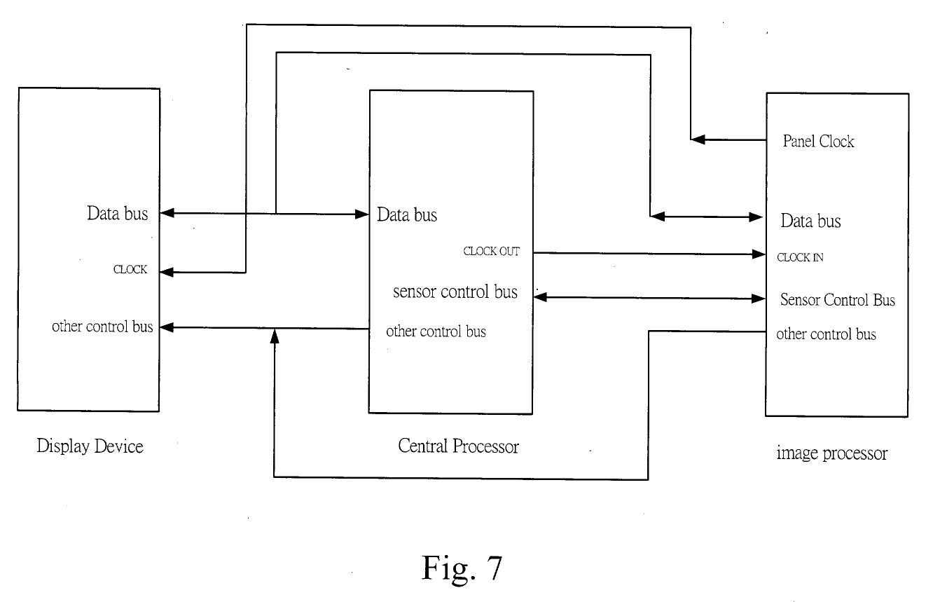

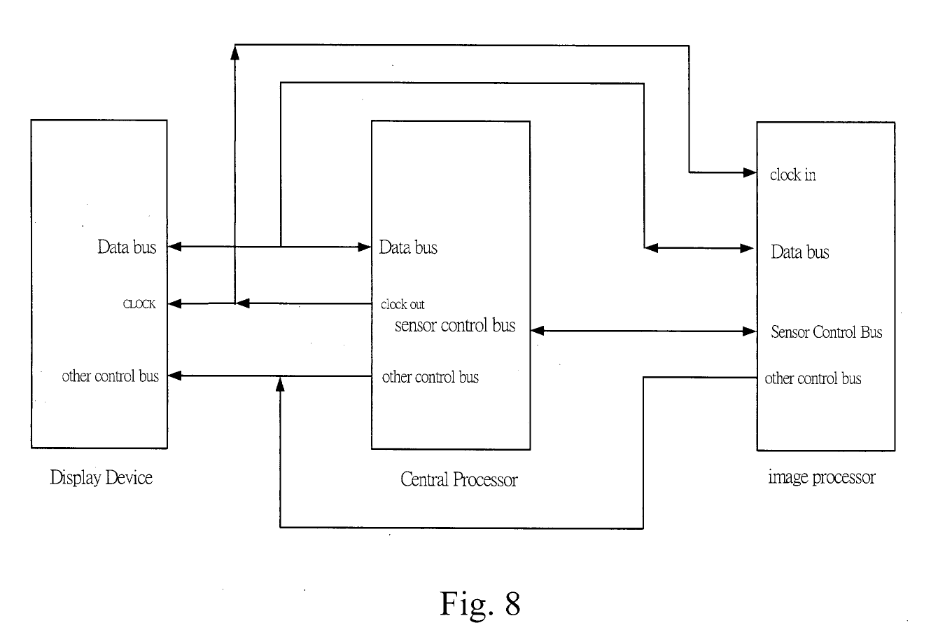

Please refer to FIGS. 6, 7 and 8, which show several possible interconnections of clock signal provided in the image data transmission device according to the present invention. It can be seen from these diagrammatic circuitries that CS pin can be connected to other control bus instead. As shown in FIG. 7, the clock signal of the central processor is transmitted to the image processor and the clock signal of the image processor is then transmitted to the display device. The benefit of such clock signal interconnection is that clock signal lines are not needed to be connected in parallel, so that the timings of the image data transmission operations by the image processor and the central processor are conformable with the clock signal. As shown in FIG. 8, the clock signal of the central processor is respectively transmitted to the clock input pin of the image processor and the display device. The benefit of such clock signal interconnection is that clock signal used in the whole system is provided by the central processor, so that the timings of the image data transmission operations by the image processor and the central processor are conformable with clock signal.

Further, the clock signal output pin of the central processor is connected with the clock signal input pin of the display device 100, and the clock signal output pin of the image processor 300 is also connected with the clock signal input pin of the display device 100. The clock signal transportation can be conducted by either transmitting the clock signal of the central processor to the display device, or by transmitting the clock signal of the image processor to the display device, as shown in FIG. 6. An alternative clock signal connection configuration can be arranged by connecting the clock signal output pin of the central processor with the clock signal input pin of the image processor, and connecting the clock signal output pin of the image processor with the clock signal input pin of the display device. The clock signal transportation can be conducted by transmitting the clock signal of the central processor to the image processor, and then transmitting the clock signal of the image processor to the display device, as shown in FIG. 7. Another alternative clock signal connection configuration can be arranged by connecting the clock signal output pin of the central processor with the clock signal input pin of the display device and the clock signal input pin of the image processor. The clock signal transportation can be conducted by transmitting the clock signal of the central processor 200 to the display device and image processor respectively, as shown in FIG. 8.

In conclusion with the above statements, it is known that although the present invention has been described and illustrated in detail, it is to be clearly understood that the same is by the way of illustration and example only and is not to be taken by way of limitation, the spirit and scope of the present invention being limited only by the terms of the appended claims.

What is claimed is:

1. An image data transmission method for transmitting an image data to a display device, the image data transmission method comprising the steps of:
presetting a image data dimension and location to be displayed on the display device;
configuring at least one data bus wiring and one control bus wiring connected to the display device as floating-connected by a central processor;
sending a message by the central processor to notify an image processor to send the image data to the display device; and
sending the image data directly from the image processor to the display device.

2. The image data transmission method according to claim 1 wherein the floating connections between the data bus wiring and the control bus wiring to the display device are achieved by a software program.

3. The image data transmission method according to claim 1 wherein the message is a specific signal transmitted over signal lines.

4. The image data transmission method according to claim 2 wherein the message is a registration information of the software program.

5. The image data transmission method according to claim 1 wherein an image data dimension and location to be displayed on the display device are preset by the central processor.

6. The image data transmission method according to claim 1 wherein an image data dimension and location to be displayed on the display device are preset by the image processor.

7. The image data transmission method according to claim 1 wherein an either-or situation is that a clock signal of the central processor is transmitted to the display device, or a clock signal of the image processor is transmitted to the display device.

8. The image data transmission method according to claim 1 wherein a clock signal of the central processor is transmitted to the image processor, and a clock signal of the image processor is transmitted to the display device.

9. The image data transmission method according to claim 1 wherein a clock signal of the central processor is respectively transmitted to the image processor and the display device.

10. An image data transmission device comprising:
a display device for exhibiting an image data;
a central processor connected with the display device; and
an image processor interconnected with the display device and the central processor.

11. The image data transmission device according to claim 10 wherein the display device is a thin-film transistor liquid crystal display.

12. The image data transmission device according to claim 10 wherein the display device is a super twisted nematic liquid crystal display.

13. The image data transmission device according to claim 10 wherein the display device is an organic light emitting device.

14. The image data transmission device according to claim 10 wherein the central processor is furnished with a memory device.

15. The image data transmission device according to claim 10 wherein the central processor is a digital signal processor.

16. The image data transmission device according to claim 10 wherein the central processor is a central processing unit for a personal computer.

17. The image data transmission device according to claim 10 wherein the central processor is a system-on-chip device.

18. The image data transmission device according to claim 10 wherein the central processor is a digital still camera controller.

19. The image data transmission device according to claim 10 wherein the central processor is a baseband processor.

20. The image data transmission device according to claim 10 wherein the image processor is furnished with an image sensor.

21. The image data transmission device according to claim 20 wherein the image sensor comprises a charge-coupled device.

22. The image data transmission device according to claim 20 wherein the image sensor comprises a CMOS device.

23. The image data transmission device according to claim 10 wherein electric wires between the display device and the central processor as well as the image processor at least comprise one data bus wiring and one control bus wiring.

24. The image data transmission device according to claim 23 wherein a portion of the data bus wiring and the control bus wiring are connected in parallel with the central processor.

25. The image data transmission device according to claim 10 wherein a clock signal output pin of the central processor is connected with a clock signal input pin of the display device, and a clock signal output pin of the image processor is connected with a clock signal input pin of the display device.

26. The image data transmission device according to claim 10 wherein a clock signal output pin of the central processor is connected with a clock signal input pin of the image processor, and a clock signal output pin of the image processor is connected with a clock signal input pin of the display device.

27. The image data transmission device according to claim 10 wherein a clock signal output pin of the central processor is respectively connected with a clock signal input pin of the image processor and a clock signal input pin of the display device.
